(19) United States
(12) Patent Application Publication
(10) Pub. No.: US 2016/0191895 A1
(43) Pub. Date: Jun. 30, 2016

(54) SUPER MULTI-VIEW IMAGE SYSTEM AND DRIVING METHOD THEREOF

(71) Applicant: Electronics and Telecommunications Research Institute, Daejeon (KR)

(72) Inventor: Jae Kwan YUN, Daejeon (KR)

(21) Appl. No.: 14/977,114

(22) Filed: Dec. 21, 2015

(30) Foreign Application Priority Data
Dec. 30, 2014 (KR) 10-2014-0194076

(51) Int. Cl. H04N 13/00

(52) U.S. Cl. CPC H04N 13/0059; H04N 13/0018; H04N 13/0048; H04N 13/0051

(57) ABSTRACT

There are provided a super multi-view image system and a driving method thereof, which can distribute and transmit a super multi-view image. A super multi-view image system includes an image bit stream generating unit for generating bit stream data of a super multi-view image, a storing/transmitting unit for distributing and storing image data generated by dividing the bit stream data in a plurality of storage servers, and a receiving/displaying unit for implementing an image by using image data transmitted from the storing/transmitting unit. In the super multi-view image system, the storing/transmitting unit simultaneously transmits, to the receiving/displaying unit, the image data distributed and stored in the plurality of storage servers.

### RELATED APPLICATIONS

This application claims priority to and the benefit of Korean Patent Application No. 10-2014-0194076, filed on Dec. 30, 2014, in the Korean Intellectual Property Office, the entire contents of which are incorporated herein by reference in their entirety.

### BACKGROUND

1. Field

An aspect of the present disclosure relates to a super multi-view image system and a driving method thereof, and more particularly, to a super multi-view image system and a driving method thereof, which can distribute and transmit a super multi-view image.

2. Description of the Related Art

With the development of broadcast communication technologies, image systems, and image compression technologies, high-definition broadcast services such as high-definition TV (HDTV) are provided. In addition to these services, there are increased demands for three-dimensional images capable of perfectly reproducing things that a user experiences in reality by totally stimulating user's five senses. As demands for images are shifted from two-dimensional images to three-dimensional images, video photographing, transmitting, storing, and reproducing systems are also changed into forms which are further developed than the existing systems.

Meanwhile, studies on a super multi-view have been actively conducted to express realistic images. Two or more adjacent viewpoint images should be simultaneously projected to a viewer's pupil so as to implement continuous parallax possessed by an actual object. To this end, studies on a super multi-view image having a number of images (i.e., a number of viewpoints) remarkably increased as compared with a multi-view image have been conducted.

In order to implement a super multi-view image, the resolution of the image should be improved, and simultaneously, the size of pixels should be increased. However, if the number and size of pixels and the number of viewpoints are increased, the size of an image for reflecting the increased number and size of pixels and the increased number of viewpoints are also increased. If the number of viewpoints is equal to or greater than a specific number of viewpoints (e.g., 72 viewpoints), it is difficult to simultaneously store, transmit, and reproduce the super multi-view image. For example, the multi-view image is set to large-capacity data which is a few times to a few tens of times of that of a single-view image, and the super multi-view image is set to enormously big data which is a few times to a few tens of times of that of the multi-view image. Therefore, a separate system is required to store, transmit, and reproduce the super multi-view image.

### SUMMARY

Embodiments provide a super multi-view image system and a driving method thereof, which can distribute and transmit a super multi-view image.

According to an aspect of the present disclosure, there is provided a super multi-view image system, including: an image bit stream generating unit configured to generate bit stream data of a super multi-view image; a storing/transmitting unit configured to distribute and store image data generated by dividing the bit stream data in a plurality of storage servers; and a receiving/displaying unit configured to implement an image by using image data transmitted from the storing/transmitting unit, wherein the storing/transmitting unit simultaneously transmits, to the receiving/displaying unit, the image data distributed and stored in the plurality of storage servers.

The image bit stream generating unit may include an image sequencer configured to generate image sequence data by using super multi-view image data filmed from each viewpoint; an image compressor configured to compress the super multi-view image data; and a bit stream generator configured to generate the bit stream data by using the compressed image data.

The image compressor may extract reference data to be shared between image data at a specific view point and adjacent image data at another viewpoint, and compress the image data such that extracted reference data is shared.

The storing/transmitting unit may include an image decoder configured to restore the bit stream data to the original image data; an image divider configured to divide the image data; and an image distribution store configured to distribute and store image data divided by the image divider in the plurality of storage servers.

The image divider may divide the image data to correspond to the respective viewpoints.

The storing/transmitting unit may further include an image frame distribution indexer configure to generates, as indexes, time orders and stored positions of the image data stored in the plurality of storage servers; an image searcher configured to retrieve an image to be transmitted among the image data stored in the plurality of storage servers; and a frame synchronizer configured to extract the image data in a time order of an image sequence, corresponding to the retrieve of the image searcher, and perform synchronization such that the image data is reproduced in the original order.

The receiving/displaying unit may include an image receiver configured to receive the image data; an image analyzer configured to separate the received image data corresponding to an order of images; an image sequence generator configured to generate image sequence data by using the image data separated by the image analyzer; an image mapper configured to map the image sequence data to images to be displayed; an image order renderer configured to render the mapped image sequence data; an image load balancer configured to redivide the rendered image sequence data; and a display configured to display images by using the redivided image sequence data.

The image analyzer may separate the image data, corresponding to a time order of the viewpoints.

The receiving/displaying unit may further include an error detector configured to detect and correct an error of the image data.

The super multi-view image system may further include a storing unit configured to store the bit stream data of the super multi-view image.

According to an aspect of the present disclosure, there is provided a method of driving a super multi-view image system, the method including: distributing and storing a super multi-view image data in a plurality of storage servers; simultaneously transmitting the image data stored in the plurality of storage severs; and implementing images by receiving the image data.

The super multi-view image data may be divided corresponding to a time order of respective viewpoints and be stored in the plurality of storage servers.

### BRIEF DESCRIPTION OF THE DRAWINGS

Example embodiments will now be described more fully hereinafter with reference to the accompanying drawings; however, they may be embodied in different forms and should not be constructed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a super multi-view image system according to an embodiment of the present disclosure.

FIG. 2 is a diagram illustrating an embodiment of an image bit stream generating unit shown in FIG. 1.

FIG. 3 is a diagram illustrating an embodiment of a storing/transmitting unit shown in FIG. 1.

FIG. 4 is a diagram illustrating an embodiment of a receiving/displaying unit shown in FIG. 1.

FIG. 5 is a diagram illustrating an embodiment of an operating process of an image sequencer shown in FIG. 2.

FIG. 6 is a diagram illustrating an embodiment of an operating process of an image loader, an image compressor, and a bit stream generator, shown in FIG. 2.

FIG. 7 is a diagram illustrating an embodiment of an operating process of an image decoder, an image divider, an image distribution store, an image frame distribution indexer, and a frame synchronizer, shown in FIG. 3.

FIG. 8 is a diagram illustrating an embodiment of an operating process of an image searcher and an image transmitter, shown in FIG. 3, and the receiving/displaying unit shown in FIG. 4.

### DETAILED DESCRIPTION

In the following detailed description, only certain exemplary embodiments of the present disclosure have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive.

In the entire specification, when an element is referred to as being “connected” or “coupled” to another element, it can be directly connected or coupled to the another element or be indirectly connected or coupled to the another element with one or more intervening elements interposed therebetween. In addition, when an element is referred to as “including” a component, this indicates that the element may further include another component instead of excluding another component unless there is different disclosure. Like reference numerals refer to like elements throughout.

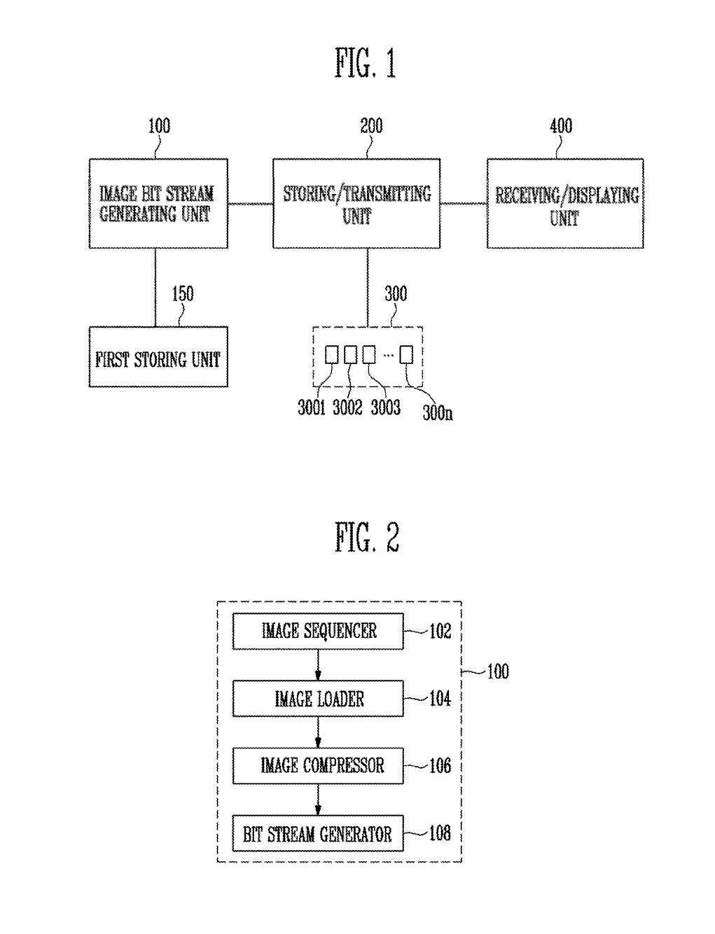

FIG. 1 is a diagram illustrating a super multi-view image system according to an embodiment of the present disclosure.

Referring to FIG. 1, the super multi-view image system according to the embodiment of the present disclosure includes an image bit stream generating unit 100, a first storing unit 150, a storing/transmitting unit 200, a second storing unit 300, and a receiving/displaying unit 400.

The image bit stream generating unit 100 generates bit stream data of a super multi-view image. The image bit stream generating unit 100 stores the generated bit stream data of the super multi-view image in the first storing unit 150, and supplied the stored bit stream data of the super multi-view image to the storing/transmitting unit 200.

The storing/transmitting unit 200 distributes and stores bit stream data of a super multi-view image in the second storing unit 300, i.e., a plurality of storage servers 300l to 300n. For example, the storing/transmitting unit 200 may distribute and store, in the storage servers 300l to 300n, image data respectively corresponding to viewpoints. Also, the storing/transmitting unit 200 simultaneously transmits, to the receiving/displaying unit 400, super multi-view image data of the super multi-view image, stored in the storage servers 300l to 300n.

The receiving/displaying unit 400 receives super multi-view image data transmitted from the storing/transmitting unit 200, and display the received image data.

FIG. 2 is a diagram illustrating an embodiment of the image bit stream generating unit shown in FIG. 1. In FIG. 2, the image bit stream generating unit is functionally divided, and may be implemented with one or more servers.

Referring to FIG. 2, the image bit stream generating unit 100 includes an image sequencer 102, an image loader 104, an image compressor 106, and a bit stream generator 108.

The image sequencer 102 generates image sequence data by using super multi-view image data filmed from each viewpoint. Therefore, it is assumed that, in the embodiment of the present disclosure, elements of a super multi-view sequence are made by listing images respectively corresponding to viewpoints. That is, the image sequencer 102 of the present disclosure generates image sequence data in a manner that lists images respectively corresponding to viewpoints.

The image loader 104 loads image sequence data generated by the image sequencer 102 (i.e., image sequence loading). Here, the capacity of the image sequence data loaded from the image loader 104 increases by geometric progression as the number of viewpoints increases, and hence the size of the image sequence data is reduced by using the image compressor 106 together with the loading of the image sequence data.

The image compressor 106 may minimize the size of image sequence data by compressing the image sequence data. Since super multi-view sequence data is generated by filming one object at various viewpoints, similarities exist between images at the respective viewpoints. That is, a super multi-view image at a specific viewpoint and an adjacent super multi-view image have an almost similar data value with respect to filmed images, except that a slight angle difference exists. Based on this, the image compressor 106 extracts reference data to be shared between images at adjacent viewpoints, and compresses the image sequence data such that extracted reference data is shared.

The image sequence data compressed by the image compressor 106 is generated as bit stream data by the bit stream generator 108. The bit stream data generated by the bit stream generator 108 is stored in the first storing unit 150.

FIG. 3 is a diagram illustrating an embodiment of the storing/transmitting unit shown in FIG. 1. In FIG. 3, the storing/transmitting unit is functionally divided, and may be implemented with one or more servers.

Referring to FIG. 3, the storing/transmitting unit 200 according to the embodiment of the present disclosure includes an image decoder 202, an image divider 204, an image distribution store 206, an image frame distribution indexer 208, a frame synchronizer 210, an image searcher 212, and an image transmitter 214.

The image decoder 202 receives bit stream data supplied from the image bit stream generating unit 100. The image decoder 202 receiving the supplied bit stream data restores the original image data by using the bit stream data.

The image divider 204 divides image data with a specific reference. For example, the image divider 204 may divide image data, corresponding to respective viewpoints. The image data divided by the image divider 204 are distributed and stored in the storage servers 300l to 300n by the image distribution store 206. That is, the image divider 204 and the image distribution store 206 divide image data, corresponding to respective viewpoints, and distribute and store the divided data in the storage servers 300l to 300n. Here, each of the storage servers 300l to 300n stores image data corresponding to at least one viewpoint, and image data for the respective viewpoints exist adjacent to each other for the purpose of fast processing.

After the image data are stored in the storage severs 300l to 300n, the image frame distribution indexer 208 generates, as an index, a time order and a stored position of image data corresponding to each viewpoint. Thus, the stored position of the image data corresponding to each viewpoint can be detected by the index generated by the image frame distribution indexer 208.

The image searcher 212 retrieves image data stored in the storage servers 300l to 300n. For example, the image searcher 212 may retrieve image data to be transmitted to the receiving/displaying unit 400.

The frame synchronizer 210 extracts image data from the storage servers 300l to 300n, corresponding to the retrieve of the image searcher 212. Here, the frame synchronizer 210 extracts image data in a time order of an image sequence, corresponding to an index, and performs synchronization such that the image data is reproduced in the original order.

The image transmitter 214 transmits image data to the receiving/displaying unit 400, corresponding to a retrieve result from the image searcher 212. Here, the image transmitter 214 simultaneously transmits, to the receiving/displaying unit 400, image data stored in the storage servers 300l to 300n.

For example, the image transmitter 214 allows image data to be simultaneously transmitted to the receiving/displaying unit 400 from the plurality of storage servers 300l to 300n by using information on image data extracted by the frame synchronizer 210. In this case, the image data transmitted from the storage servers 300l to 300n are transmitted in a synchronized time order.

As described above, in the present disclosure, the storing/transmitting unit 200 distributes and stores image data, corresponding to the viewpoints, and simultaneously transmits the distributed and stored image data to the receiving/displaying unit 400. Then, the sizes of the respective image data are minimized, and accordingly, the image data can be stably transmitted. Also, if image data are not transmitted to one server but transmitted to a plurality of servers, a bottleneck phenomenon of network resources can be prevented, and image data corresponding to respective viewpoints can be transmitted in a synchronized time order.

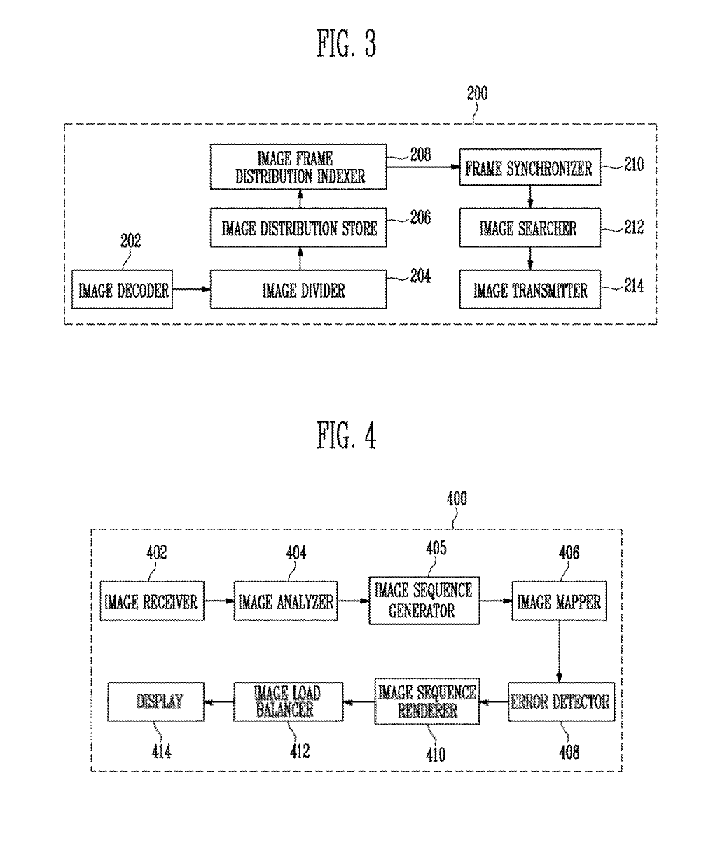

FIG. 4 is a diagram illustrating an embodiment of the receiving/displaying unit shown in FIG. 1. In FIG. 4, the receiving/displaying unit is functionally divided, and may be implemented with one or more servers.

Referring to FIG. 4, the receiving/displaying unit 400 includes an image receiver 402, an image analyzer 404, an image sequence generator 405, an image mapper 40, an error detector 408, an image sequence renderer 410, an image load balancer 412, and a display 414.

The image receiver 402 receives image data from the image transmitter 214.

The image analyzer 404 separates the image data received by the image receiver 402 in an order of a super multi-view image (e.g., a synchronized time order at each viewpoint).

The image sequence generator 405 generates image sequence data by using the image data separated by the image analyzer 404.

The image mapper 406 maps image sequence data to images to be displayed at super multi-viewpoints.

The error detector 408 detects an error generated in a process of transmitting and receiving image data. That is, the error detector 408 detects a transmission error of image data or an error generated in a mapping process, and performs a correcting process corresponding to error data when the error is detected. For example, the error detector 408 may request re-transmission, corresponding to image data in which an error is generated. That is, the error detector 408 may wait when the image data arrives earlier than a synchronized order, and discard the image data when the image data repeatedly arrives or when the image data arrives later than the synchronized order.

The image sequence renderer 410 performs a rendering process, corresponding to image sequence data. That is, the image sequence renderer 410 reconstructs image sequence data to be displayed as a super multi-view image, corresponding to the display 414.

The image load balancer 412 redivides image sequence data. That is image load balancer 412 redivides image sequence data to be displayed as a super multi-view image in the display 414. For example, the image load balancer 412 may redivide image sequence data, corresponding to a scan order of the display unit 414 (e.g., a super multi-view display may redivide image sequence data suitable for the display such that image data corresponding to viewpoints are differently displayed according to user's eyeball angles).

The display 414 displays images by using the image sequence data redivided by the image load balancer 412.

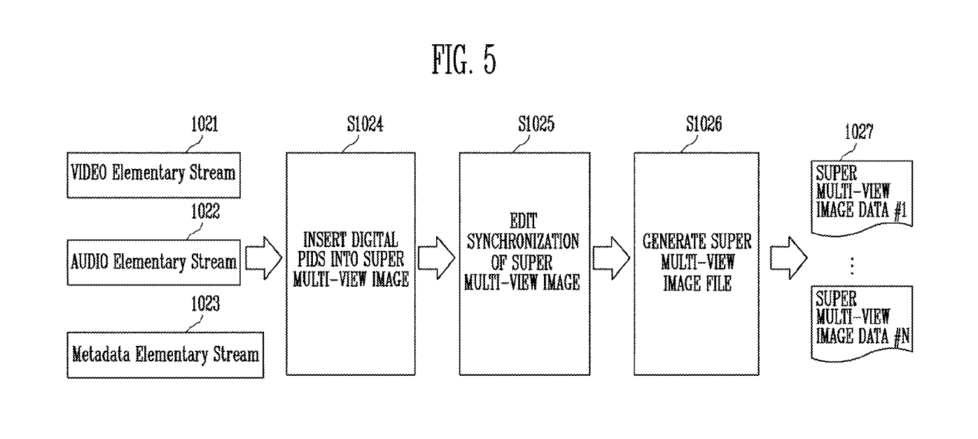

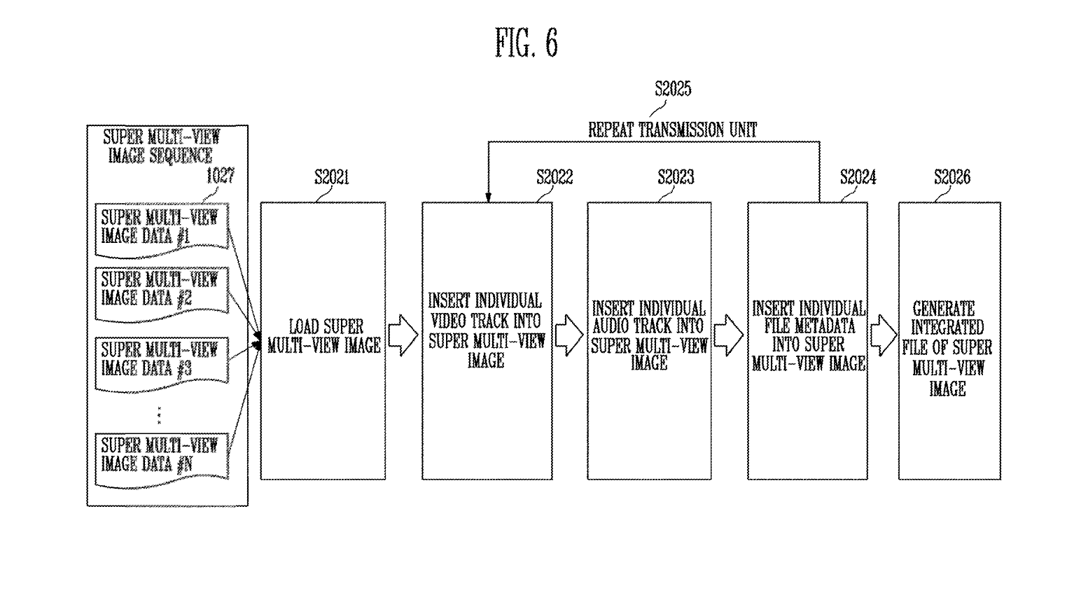

FIG. 5 is a diagram illustrating an embodiment of an operating process of the image sequencer shown in FIG. 2.

Referring to FIG. 5, super multi-view image data input to the image sequencer 102 from the outside may be configured as an MPEG-4 file having a video elementary stream 1021, an audio elementary stream 1022, and a metadata elementary stream 1023. Here, the video elementary stream 1021 includes video information, and the audio elementary stream 1022 includes audio information. The video elementary stream 1021 and the audio elementary stream 1022 are binarized and stored. The metadata elementary stream 1023 includes attribute information, and is stored in a text or a binary form.

The image sequencer 102 inserts a unique digital packet ID (PID) into each of the video elementary stream 1021, the audio elementary stream 1022, and the metadata elementary stream 1023 (S1024).

Subsequently, the image sequencer 102 synchronizes audio data, video data, and metadata to be suitable for a program clock reference (PCR) by considering a decoding time stamp (DTS) and a presentation time stamp (PTS) such that the audio data, the video data, and the metadata can be displayed in the same time zone (S1025).

Then, the image sequencer 102 generates the synchronized audio data, video data, and metadata as one file (S1025). Super multi-view image data 1027 generated as described above may be generated according to the number of viewpoints. For example, if N viewpoints (including both the number of horizontal viewpoints and the number of vertical viewpoints) are included in a super multi-view image, N super multi-view image data 1027 may be generated (image sequence data generation).

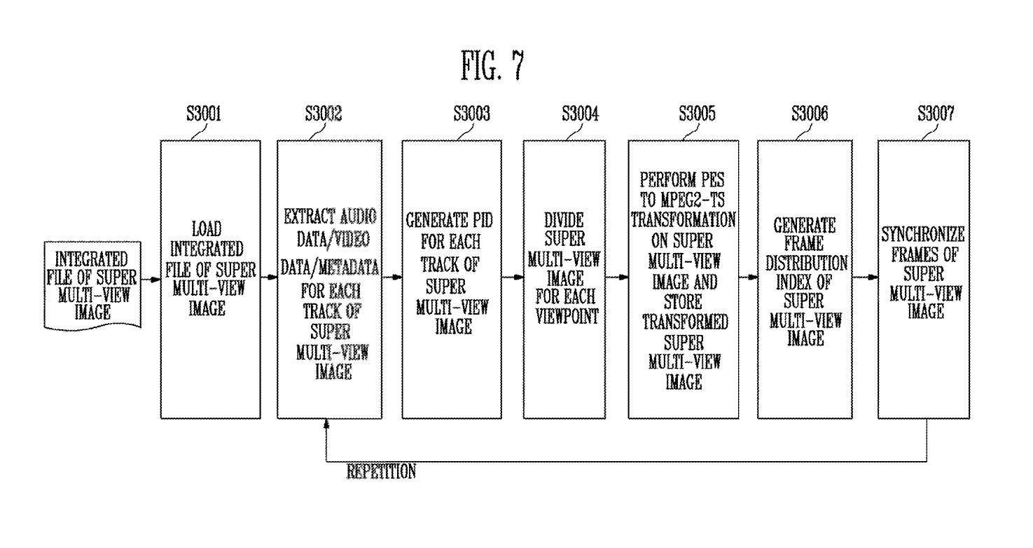

FIG. 6 is a diagram illustrating an embodiment of an operating process of the image loader, the image compressor, and the bit stream generator, shown in FIG. 2.

Referring to FIG. 6, the image loader 104 loads image sequence data stored as an MPEG-4 file (S2021). The image sequence data loaded by the image loader 104 is stored in an order of audio data, video data, and metadata. The image compressor 106 stores the audio data and the video data in a track box of the MPEG-4 file and stores the metadata in a meta box of the MPEG-4 file, corresponding to the stored order of the image sequence data (S2022 to S2024). In this case, the image compressor 106 extracts reference data and allows the extracted reference data to be shared, thereby compresses the image sequence data.

Meanwhile, steps S2022 to S2024 are repeated by the number of viewpoints of a super multi-view image (S2025). Subsequently, the bit stream generator 108 generates the compressed image sequence data as bit stream data that is one integrated file (S2026).

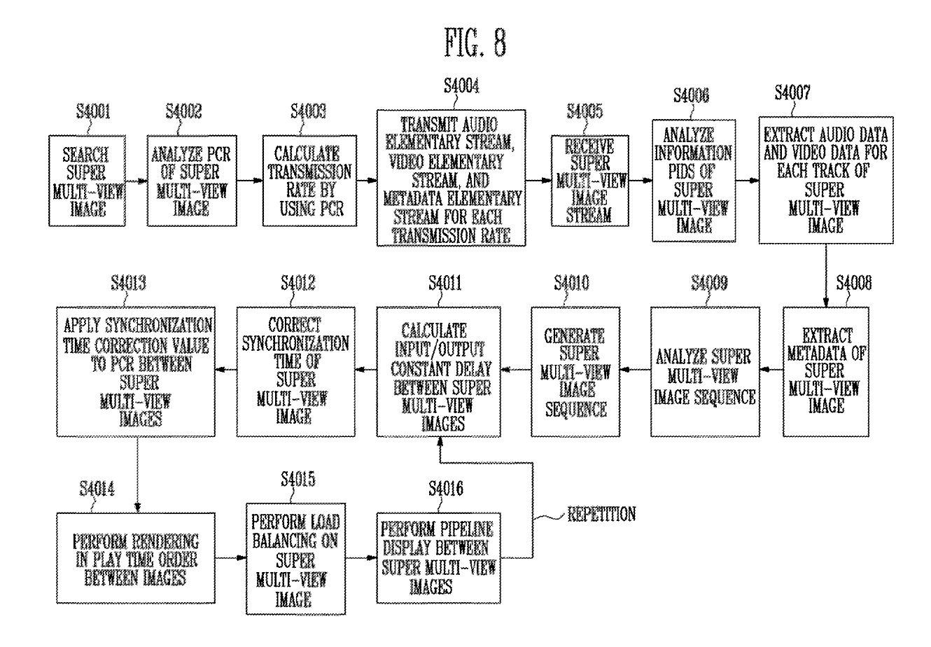

FIG. 7 is a diagram illustrating an embodiment of an operating process of the image decoder, the image divider, the image distribution store, the image frame distribution indexer, and the frame synchronizer, shown in FIG. 3.

Referring to FIG. 7, bit stream data transmitted from the image bit stream generating unit 100 is loaded by the image decoder 202 (S3001). Here, step S3001 may be performed by a separate loader.

After the bit stream data is loaded, the image decoder 202 extracts audio data, video data, and metadata (S3002). That is, the image decoder 202 extracts audio data and video data, stored in the track box, and metadata stored in the meta box (S3002). Then, the image decoder 202 generates PIDs of the video data, the audio data, and the metadata (S3003). The original image data is restored by undergoing steps S3002 and 3003.

Subsequently, the image divider 204 divides image data, corresponding to respective viewpoints, by using the restored original image data (S3004). The divided image data for the respective viewpoints are transformed to an MPES2-TS stream through packetized elementary stream to MPEG-2 transport stream (PES to MPEG2-TS) transformation. The image data transformed to the MPEG2-TS stream are distributed and stored in the storage servers 300l to 3000n by the image distribution store 206 (S3005).

Subsequently, the image frame distribution indexer 208 generates, as an index, an order and a stored position of each image data for the purpose of retrieve and transmission (S3006). Then, the frame synchronizer 210 records an order to be synchronized in an order of image sequence data, corresponding to the generated index (S3007).

FIG. 8 is a diagram illustrating an embodiment of an operating process of the image searcher and the image transmitter, shown in FIG. 3, and the receiving/displaying unit shown in FIG. 4.

Referring to FIG. 8, the image searcher 212 retrieves an image to be transmitted among images stored in the storage servers 300l to 300n (S4001). The image searcher 212 may retrieve an image to be transmitted by using an index. After the image is retrieved, the image searcher 212 extracts a PCR of each image by using a PCR analyzer (S4002). The PCR extracted in step S4002 is used to calculate a round trip delay (RTD) where an image at each viewpoint is transmitted through a rate calculator (S4003).

After the RTD is calculated, the image transmitter 214 simultaneously transmits image data (an audio elementary stream, a video elementary stream, and a metadata elementary stream) stored in the storage servers 300l to 300n (S4004).

Since the image data transmitted from the image transmitter 214 are simultaneously transmitted from the distributed storage servers 300l to 300n, the image receiver 402 receives by using a plurality of receiving buffers (not shown) (S4005).

After the image data are received to the image receiver 402, the image analyzer 404 analyzes information on PIDs and aligns the image data in an order of the analyzed PIDs (S4006) (e.g., the image data are aligned in a synchronized time order at each viewpoint). Then, image analyzer 404 extracts audio data, video data, and metadata (S4007 and S4008).

The image sequence generator 405 analyzes an image order by using the image data received from the image receiver 402, and restores the original image sequence, corresponding to the analyzed image order (S4009 and S4010). That is, the image sequence generator 405 generates the original image sequence data.

The image mapper 406 calculates an input/output constant delay between super multi-view images so as to reproduce image sequence data, and applies a synchronization time correction value to the PCR by considering the input/output constant delay (S4011, S4012, and S4013).

The image sequence renderer 410 renders images corresponding to the respective viewpoints through play time sequence rendering between images (S4014).

The image load balancer 412 redistributes the image data, corresponding to the rendering result (S4015).

The display 414 displays an image by using the image sequence data redistributed by the image load balancer 412 (S4016). Here, a super multi-view image pipeline display may be used as the display 414. The super multi-view image pipeline display is used to display super multi-view images.

Since a data difference between images at respective viewpoints of a super multi-view image is nor large (since similar images are filmed with a slight angle different, another image can be stored by using one image), an image can be restored by using reference data. In this restoring process, a time delay may occur, and the pipeline display may delay time until the image is restored. That is, the pipeline display includes a function of generating all reference images, restoring an image at a viewpoint referred by using reference data, and then display the image.

In the super multi-view image system and the driving method thereof according to the present disclosure, super multi-view image data is distributed for each viewpoint, and the distributed image data are stored in a plurality of storage servers. Then, the stored image data are simultaneously transmitted. In this case, the size of the transmitted data is minimized, and accordingly, the image data can be stably transmitted. Also, in the present disclosure, index information is separately managed corresponding to the image data stored in the plurality of storage servers, so that a stored position can be quickly retrieved. Also, in the present disclosure, synchronization information is managed together with the index information, so that it is possible to reduce a transmission error at a viewpoint in transmission and an error in display.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A super multi-view image system, comprising:
an image bit stream generating unit configured to generate bit stream data of a super multi-view image;
a storing/transmitting unit configured to distribute and store image data generated by dividing the bit stream data in a plurality of storage servers; and
a receiving/displaying unit configured to implement an image by using image data transmitted from the storing/transmitting unit,
wherein the storing/transmitting unit simultaneously transmits, to the receiving/displaying unit, the image data distributed and stored in the plurality of storage servers.

2. The super multi-view image system of claim 1, wherein the image bit stream generating unit includes:
an image sequencer configured to generate image sequence data by using super multi-view image data filmed from each viewpoint;
an image compressor configured to compress the super multi-view image data; and
a bit stream generator configured to generate the bit stream data by using the compressed image data.

3. The super multi-view image system of claim 2, wherein the image compressor extracts reference data to be shared between image data at a specific view point and adjacent image data at another viewpoint, and compresses the image data such that extracted reference data is shared.

4. The super multi-view image system of claim 1, wherein the storing/transmitting unit includes:
an image decoder configured to restore the bit stream data to the original image data;
an image divider configured to divide the image data; and
an image distribution store configured to distribute and store image data divided by the image divider in the plurality of storage servers.

5. The super multi-view image system of claim 4, wherein the image divider divides the image data to correspond to the respective viewpoints.

6. The super multi-view image system of claim 4, wherein the storing/transmitting unit further includes:
an image frame distribution indexer configure to generates, as indexes, time orders and stored positions of the image data stored in the plurality of storage servers;
an image searcher configured to retrieve an image to be transmitted among the image data stored in the plurality of storage servers; and
a frame synchronizer configured to extract the image data in a time order of an image sequence, corresponding to the retrieve of the image searcher, and perform synchronization such that the image data is reproduced in the original order.

7. The super multi-view image system of claim 1, wherein the receiving/displaying unit includes:an image receiver configured to receive the image data;
an image analyzer configured to separate the received image data corresponding to an order of images;
an image sequence generator configured to generate image sequence data by using the image data separated by the image analyzer;
an image mapper configured to map the image sequence data to images to be displayed;
an image order renderer configured to render the mapped image sequence data;
an image load balancer configured to redivide the rendered image sequence data; and
a display configured to display images by using the redivided image sequence data.

8. The super multi-view image system of claim 7, wherein the image analyzer separates the image data, corresponding to a time order of the viewpoints.

9. The super multi-view image system of claim 7, wherein the receiving/displaying unit further includes an error detector configured to detect and correct an error of the image data.

10. The super multi-view image system of claim 1, further comprising a storing unit configured to store the bit stream data of the super multi-view image.

11. A method of driving a super multi-view image system, the method comprising:
distributing and storing a super multi-view image data in a plurality of storage servers;
simultaneously transmitting the image data stored in the plurality of storage severs; and
implementing images by receiving the image data.

12. The method of claim 11, wherein the super multi-view image data is divided corresponding to a time order of respective viewpoints and stored in the plurality of storage servers.
